(19) United States
(12) Patent Application Publication
(10) Pub. No.: US 2026/0247387 A1
(43) Pub. Date: Aug. 20, 2026

(54) SIGNALING OF UNUSED CONFIGURED GRANT TRANSMISSION OCCASIONS

(71) Applicant: Telefonaktiebolaget LM Ericsson (publ), Stockholm (SE)

(72) Inventors: Jonas FRÖBERG OLSSON, Ljungsbro (SE); Bikramjit SINGH, Raasepori (FI); Sorour FALAHATI, Stockholm (SE); Robert KARLSSON, Sundbyberg (SE); Du Ho KANG, Sollentuna (SE)

(21) Appl. No.: 19/156,652

(22) PCT Filed: Feb. 16, 2024
(86) PCT No.: PCT/SE2024/050164

§ 371 Date: Aug. 14, 2025

Related U.S. Application Data
(60) Provisional application No. 63/446,600, filed on Feb. 17, 2023.
(60) Provisional application No. 63/446,631, filed on Feb. 17, 2023.

(51) Int. Cl. H04W 72/21; H04L 43/087; H04L 69/322

(52) U.S. Cl. CPC H04W 72/21; H04L 43/087; H04L 69/322

(57) ABSTRACT

A method performed by a UE in a wireless communication network includes receiving, from the wireless communication network, a configured grant that configures the UE with the set of transmission occasions for performing uplink transmission, identifying a subset of transmission occasions, within the set of transmission occasions, that will all be used, may be used, or will not be used, by the UE to perform uplink transmission, determining a pattern of the identified subset of transmission occasions, and transmitting, to the wireless communication network, an indicator that indicates the pattern of the identified subset of transmission occasions.

### TECHNICAL FIELD

The present disclosure relates to wireless communications, and in particular to wireless communication networks that use configured grants.

### BACKGROUND

Extended Reality (XR) includes services provided by computer technologies and wearables that allow for human-machine interaction in real/virtual mixed environments. XR includes Virtual Reality (VR), Augmented Reality (AR), Mixed Reality (MR), Cloud Gaming, and related applications. As such, XR is usually considered a mixed enhanced mobile broadband (eMBB)/ultra-reliable low latency communication (URLLC) service. As shown in Table 1, XR traffic is a mixture of heterogeneous uplink (UL)/downlink (DL) data flows, including video, audio, and control traffic.

TABLE 1
XR traffic characteristics and requirements identified by 3GPP.

| | | Data rate | Packet (frame) | Packet Delay Budget |
|---|---|---|---|---|
| | | [Mbps] | rate [fps] | (PDB) [ms] |
| DL | AR/VR Video | 30 | 60 | 10 |
| | Cloud Gaming | 30 | 60 | 15 |
| UL | Pose/control | 0.2 | 250 | 10 |
| | Video (Scene) | 10 | 60 | 30 |

Table 1 indicates that XR traffic flows have different characteristics (e.g., packet rate in frame per second [fps] and bit rate in bit per second [bps]) and requirements in terms of (application) packet delay budget (PDB) [ms]. Among XR flows, DL video and UL scene traffic are periodic (with possible jitter particularly in DL) and have variable large-sized application packets.

### Configured Grant

The ConfiguredGrantConfig information element (IE) is used to configure uplink transmission without dynamic grant according to two possible schemes. The actual uplink grant may either be configured via RRC (Type1) or provided via the PDCCH (Type2). Multiple Configured Grant (CG) configurations may be configured in one bandwidth part (BWP) of a serving cell.

For both Type 1 and Type 2 configured grants, the user equipment (UE) is provided time-frequency resources on which the UE is allowed to transmit the physical uplink shared channel (PUSCH). The time-frequency resources where UE is allowed to transmit PUSCH is herein referred to as Transmission Occasions (TOs).

For a Type 1 configured grant, the time-frequency resources are indicated using timeDomainAllocation, frequencyDomainAllocation and periodicity together with a time reference to the slot in which the TO is located indicated in a radio resource control (RRC) message. The periodicity indicates recurrence of the TOs. The timeDomainAllocation indicates the first symbol of the PUSCH and the duration of the PUSCH (in symbols) and frequencyDomainAllocation indicates the Resource Blocks (RBs) used by the PUSCH. For example, timeDomainAllocation may indicate a start symbol, e.g. startSymbol=0, and an end symbol, e.g., endSymbol=14 (i.e., the PUSCH starts in the first symbol of the slot and ends in the last symbol) and the time reference may indicate that first TO is in slot 4. If the periodicity is 5 slots, then TOs for the configured grant would be present in the slots 4, 9, 14, 19, 24, . . . . Once the UE has been configured with a Type 1 configured grant, the UE may or may transmit a PUSCH on the TOs for the configured grant until UE receives a RRC message disabling the configured grant.

The Type 2 configured grant is more flexible than the Type 1 configured grant in which the UE is provided the periodicity of the configured grant by RRC. In a Type 2 configured grant, the timeDomainAllocation and frequencyDomainAllocation are provided via the physical downlink control channel (PDCCH), which simultaneously activates the configured grant. timeDomainAllocation together when the activation downlink control information (DCI) on PDCCH is sent to UE gives the time reference for first TO. The Type 2 configured grant can be deactivated by a deactivation DCI on a PDCCH.

### Skip Uplink

The medium access control (MAC) of the UE entity may be configured to skip uplink transmission if the transport block will be empty (or only contain low priority data). In this case, the MAC entity will not generate a MAC protocol data unit (PDU), the MAC entity will not deliver a grant to the hybrid automatic repeat request (HARQ) entity, and the HARQ entity will not trigger a transmission.

### SUMMARY

A method performed by a UE in a wireless communication network includes receiving, from the wireless communication network, a configured grant that configures the UE with the set of transmission occasions for performing uplink transmission, identifying a subset of transmission occasions, within the set of transmission occasions, that will all be used, may be used, or will not be used, by the UE to perform uplink transmission, determining a pattern of the identified subset of transmission occasions, and transmitting, to the wireless communication network, an indicator that indicates the pattern of the identified subset of transmission occasions.

The set of transmission occasions may include a set of periodically repeating transmission occasions, and wherein the pattern of the identified subset of transmission occasions may include a periodically repeating pattern. The indicator may include a bitmap of the identified subset of transmission occasions. The indicator may indicate that one or more transmission occasions in the identified subset of transmission occasions are ‘unused.’

Transmission occasions in the identified subset of transmission occasions that are not indicated as ‘unused’ are considered as being ‘used’ or ‘may be used.”

The indicator may include a parameter associated with the pattern of the identified subset of transmission occasions.

The method may further include determining a plurality of patterns of the identified subset of transmission occasions, wherein the indicator indicates the plurality of patterns of the identified subset of transmission occasions.

The subset of transmission occasions may be determined based on an expected need for a periodically repeating uplink transmission requirement by a service operated by the UE.

The service operated by the UE may include an extended reality, XR, service, and the periodically repeating uplink transmission requirement may include a requirement to perform uplink transmission of XR frames at a predetermined frame rate.

The method may further include performing a physical layer procedure based on the identified subset of transmission occasions.

The subset of transmission occasions may include transmission occasions in which the UE will not perform uplink transmission.

The may further include refraining from performing uplink transmission during the subset of transmission occasions.

The subset of transmission occasions may include only those transmission occasions in the set of transmission occasions in which the UE will perform uplink transmission.

The method may further include refraining from performing uplink transmission during the transmission occasions in the set of transmission occasions other than transmission occasions in the subset of transmission occasions.

The method may further include receiving, from the wireless communication network, a confirmation of the indicator.

Transmitting the indicator to the wireless communication network may include transmitting the indicator in an uplink control information, UCI, message.

The pattern may include a set of symbols, slots, sub-slots or TOs such that a sub-set of transmission occasions is identified/referenced.

The patten may indicate an identified transmission occasion as ‘unused’, ‘used’ or ‘may be used’.

Identifying the subset of transmission occasion may be performed at a first protocol layer of the UE, and the method may further include triggering, by a second protocol layer of the UE that is lower than the first layer, the transmission to the wireless communication network of the indicator that indicates the identified subset of transmission occasions.

The first protocol layer may include a medium access control, MAC, protocol layer.

The second protocol layer may include a physical, PHY, protocol layer.

The method may further include receiving information from a third protocol layer that is higher than the first protocol layer, and using the information to identify the subset of the set of transmission occasions.

The information may include information regarding traffic that is expected to be transmitted using the subset of the set of transmission occasions.

The information may include information relating to traffic periodicity, jitter, and/or data size of the traffic that is expected to be transmitted using the subset of the set of transmission occasions.

The method may further include providing user data, and forwarding the user data to a host via the transmission to the network node.

The indicator that indicates the pattern of the identified subset of transmission occasions may be an unused transmission occasion, UTO, indicator, and the method may further include triggering, by a MAC layer, a lower layer to transmit a first UTO indicator when delivering a first MAC PDU for a TO, and triggering, by the MAC layer, the lower layer to transmit a second UTO indicator when delivering a second MAC PDU for a second TO, where the first and second TOs are different TOs.

The TOs that are indicated by the first UTO indicator as being ‘unused’ and referenced by second UTO indicator may also be indicated by second indicator as being ‘unused’.

In some embodiments, the indicator identifies transmission occasions within the subset of transmission occasions based on an offset from a slot that is part of the configured grant.

The method may further include triggering a physical, PHY, layer in the UE to perform transmission of the indicator. Triggering of the PHY layer to perform transmission of the indicator may be performed when the UE delivers a MAC PDU to a lower layer, or may be performed at a transmission occasion in the set of transmission occasions.

A method performed by a network node of a wireless communication network includes configuring a user equipment, UE, with a configured grant that configures the UE with a set of transmission occasions for performing uplink transmission, receiving an indicator from the UE indicating a pattern of transmission occasions in the set of transmission occasions that are configured for the UE for performing uplink transmission, wherein the pattern of transmission occasions corresponds to a subset of transmission occasions, within the set of transmission occasions, that will all be used, or not used, by the UE to perform uplink transmission, and allocating future transmission occasions in the set of transmission occasions based on the indicator.

The set of transmission occasions may include a set of periodically repeating transmission occasions, and wherein the pattern of transmission occasions may include a periodically repeating subset of the set transmission occasions. The indicator may include a bitmap of the identified transmission occasions. The indicator may include a parameter associated with the identified transmission occasions.

The parameter may include at least one of a starting time of the pattern, an offset that defines the starting time of the pattern, a duration of the pattern, and/or a periodicity of the pattern.

The method may further include determining a plurality of patterns of the identified transmission occasions, wherein the indicator indicates the plurality of patterns of the identified transmission occasions.

The method may further include transmitting an acknowledgement message to the UE acknowledging the indicator in response to receiving the indicator.

The indicator may indicate that the subset of the set of transmission occasions will not be used by the UE for performing uplink transmission, and the method further include re-allocating a transmission occasion in the subset of the set of transmission occasions to another UE.

The indicator may indicate that only the subset of the set of transmission occasions will be used by the UE for performing uplink transmission, and the method may further include re-allocating transmission occasions in the set of transmission occasions, other than those transmission occasions in the subset of the set of transmission occasions, to another UE.

The pattern may include a set of symbols, slots, sub-slots or TOs such that a sub-set of transmission occasions is identified/referenced.

The patten may indicate an identified transmission occasion as ‘unused’, ‘used’ or ‘may be used’.

The method may further include obtaining user data, and forwarding the user data to a host or a user equipment.

### BRIEF DESCRIPTION OF THE DRAWINGS

FIG. 1 illustrates serving XR traffic using CG on a TDD carrier with a DDDUU pattern.

FIG. 2 illustrates an example of signaling of a UTO indicator.

FIG. 3 illustrates XR frame arrival and CG configuration with a TO present in every UL slot on TDD carrier with DDDDU configuration.

FIG. 4 illustrates TOs indicated as unused with implicit indication.

FIG. 5 illustrates TOs indicated as unused with implicit indication where overprovisioning is reduced/minimized.

FIG. 6 is an illustration of periodic XR frame arrivals relative to periodic CG TOs.

FIG. 7 illustrates operations of a UE according to some embodiments.

FIG. 8 illustrates operations of a network node according to some embodiments.

FIG. 9 illustrates operations of a UE according to further embodiments.

FIG. 10 shows an example of a communication system in accordance with some embodiments.

FIG. 11 shows a UE in accordance with some embodiments.

FIG. 12 shows a network node in accordance with some embodiments.

FIG. 13 is a block diagram of a host in accordance with various aspects described herein.

FIG. 14 is a block diagram illustrating a virtualization environment in which functions implemented by some embodiments may be virtualized.

FIG. 15 shows a communication diagram of a host communicating via a network node with a UE over a partially wireless connection in accordance with some embodiments.

### DETAILED DESCRIPTION

A problem with using Configured Grants is that XR frame rates have a non-integer periodicity, e.g. a video signal that generates 60 frames/second has a periodicity of 16.67 ms. In contrast, in a 3GPP Long Term Evolution (LTE) or New Radio (NR) system, downlink (DL) and uplink (UL) transmissions are organized into radio frames of 10 ms each. Each frame is divided into ten equally sized subframes having a duration of 1 ms. Moreover, each subframe is further divided into two 0.5 ms time slots. This means that XR frame transmissions cannot maintain timing alignment with the timing of time slots used for configured grants (CG), which makes it impossible to perfectly align CG transmission occasions (TOs) with arrival of XR frames to be transmitted by the UE. This becomes especially difficult when using time division duplex (TDD) carriers.

When utilizing a CG to serve XR traffic, the gNode B (gNB) often needs to make a tradeoff between latency and overprovisioning, as illustrated in FIG. 1. In particular, FIG. 1 illustrates serving XR traffic using CG on a TDD carrier with a DDDUU pattern (i.e., three downlink time slots followed by two uplink time slots) using 30 kHz sub-carrier spacing (SCS). As shown in FIG. 1, XR frame arrivals occur according to a probability distribution at about every 16.67 ms, which may not align well with CG time slots. Overprovisioning of CG time slots can reduce alignment delays, but may lead to wasted resources, since many of the configured time slots may be unused.

During the XR study item for 3GPP Release 18, a concern has been raised that Release 17 CG leads to severe over provisioning when CG is used to serve XR traffic. Although XR traffic in uplink is expected to be periodic, the XR frame size is randomly distributed, which makes the use of CG to serve XR traffic difficult. Another problem is that the XR periodicity is not aligned with the CG periodicities that can be configured.

In the XR Work Item Description (WID) for Release 18, it has been agreed to include an objective to address the overprovisioning problem and improve XR capacity when CG is used to serve XR traffic by enabling the UE to dynamically indicate unused CG PUSCH occasion(s) based on uplink control information (UCI). In particular, the WID intends to specify the enhancements related to capacity through dynamic indication of unused CG PUSCH occasion(s) based on uplink control information (UCI) transmitted by the UE. As part of the feature design, methods to determine the content of the UCI such that it can serve the intended purpose, are needed.

Some embodiments described herein provide systems/methods for determining a set of patterns that can be used for selection of a candidate pattern to indicate the unused transmission occasions of configured grant PUSCH transmissions.

In particular, some embodiments provide systems/methods for determining the patterns, and for signaling using uplink control information to indicate the unused TOs of configured grant PUSCH transmissions. The systems/methods may define a pattern of one or more TOs as being unused. The systems/methods may further define a structure of a pattern, for example in form of bitmap or indicators indicating (offset, duration) pairs.

The systems/methods may further define a time duration when a pattern would be applicable and/or define a reference point where a pattern starts to be applicable for one or more TOs defined as unused.

Some further embodiments provide systems/methods that obtain a selected sub-set of plurality of TOs and transmit an indicator indicating the obtained selected sub-set of plurality of TOs. In particular, some embodiments trigger a lower protocol layer (e.g., the physical, or PHY, protocol layer) to perform transmission of the indicator.

For a TO of the plurality of TOs, the systems/methods perform or refrain from performing a transmission on the TO based on the transmitted indicator.

The systems/methods may consider the TO as valid or invalid based on the transmitted indicator, and/or may deliver a corresponding grant to hybrid automatic repeat request (HARQ) entity based on the transmitted indicator, or construct a medium access control (MAC) protocol data unit (PDU) based on the transmitted indicator.

Some embodiments provide a method in a UE communicating with a network node. The UE receives/obtains a plurality of TOs, such as TOs defined for a configured grant, and determines a set of sub-sets of the plurality of TOs. For example, the UE may receive a radio resource control (RRC) configuration of set of sub-sets of the plurality of TOs. The UE selects a sub-set of the sub-sets of TOs, where the selected sub-set is a set of TOs to be unused (or used) TOs, and transmits an indicator indicating the selected sub-set of TOs to the network.

The UE may receive an acknowledgement of the selected sub-set of TOs.

For a TO of the plurality of TOs, the UE may perform or refrain from performing a transmission on the TO based on the transmitted indicator.

Certain embodiments may provide one or more technical advantages. In particular, the systems/methods described herein may reduce overprovisioning when CG is used to serve XR traffic.

Some further embodiments may reduce resource utilization due to overprovisioning when CG is used to serve XR traffic. For example, some embodiments may enable a gNB to overprovision CGs. For example, a gNB may first allocate many CG opportunities to a UE. The UE may then indicate which TOs would not be used for transmission, thereby enabling the gNB to reallocate the unused resources for other purposes, such as allocating to other users.

Providing an explicit MAC procedure to trigger UCI for unused TO indications can also ensure accurate estimation of unused TOs at gNB.

Some of the embodiments contemplated herein will now be described more fully with reference to the accompanying drawings. Embodiments are provided by way of example to convey the scope of the subject matter to those skilled in the art. Additional information may also be found in the document(s) provided in the Appendices.

In the below embodiments, functionality is described for indicating TOs as being “unused” via RRC, PHY, and other higher layer configurations. However, the same embodiments can be utilized to indicate TOs as being “used” instead of unused TOs. For instance, if a UCI indicates a subset of un-used TOs, the concept in the embodiments can be used to reinterpret or repurpose the functionality to indicate “used” TOs from the group/plurality of TOs, because the “used TOs set” can be determined as the “plurality/group of TOs” MINUS the “unused TOs set.”

Some embodiments provide indications about the TOs as being “used” or “unused.” However, this does not exclude the possibility of other states. For example there may be three states “used”, “unused” and “may be used” where “may be used” indicates that the UE has not yet decided if the UE needs to use the TO or not. The UE behavior for “may be used” can, for example, be that the UE will use the TO if the UE has data to transmit and the UE does not use the TO if the UE do not have data to transmit (like how skip uplink works). The UE may be configured with which of the states (e.g., “used”, “unused”, or “may be used”) the UE is allowed to select, or which states the UE must select (e.g., the UE may not select “may be used” and must select which TOs the UE will not use).

In some embodiments, “configured uplink grant transmission”, “CG TOs”, “PUSCH duration of configured grant”, “configured grant PUSCH”, “PUSCH is correspond to a configured grant” etc., are various ways to express reference a transmission occasion where UE may transmit a PUSCH associated/assigned by a configured grant. Furthermore, in the 3GPP MAC specification, a configured grant is considered to “reoccur” or “sequentially occur” as shown in Section 5.8.2, of 3GPP TS 38.321 v17.3.0, reproduced in Table 2 below:

TABLE 2
Section 5.8.2, of 3GPP TS 38.321 v17.3.0

Upon configuration of a configured grant Type 1 for a BWP of a Serving Cell by upper layers, the MAC
entity shall:

| | |
|---|---|
| 1> | store the uplink grant provided by upper layers as a configured uplink grant for the indicated |
| | BWP of the Serving Cell; |
| 1> | initialise or re-initialise the configured uplink grant to start in the symbol according to |
| | timeDomainOffset, timeReferenceSFN, and S (derived from SLIV or provided by startSymbol as |
| | specified in TS 38.214 [7]), and to reoccur with periodicity. |

After an uplink grant is configured for a configured grant Type 1, the MAC entity shall consider
sequentially that the N^{th} (N >= 0) uplink grant occurs in the symbol for which:

```
      [(SFN × numberOfSlotsPerFrame × numberOfSymbolsPerSlot)
  + (slot number in the frame × numberOfSymbolsPerSlot) + symbol number in the slot] =
  (timeReferenceSFN × numberOfSlotsPerFrame × numberOfSymbolsPerSlot
    + timeDomainOffset × numberOfSymbolsPerSlot + S + N × periodicity)
    modulo (1024 × numberOfSlotsPerFrame × numberOfSymbolsPerSlot)
```

The concepts of “reoccurring” and “sequentially occurring” are sometimes viewed as that there are multiple TOs associated with a configured grant and sometimes viewed as that a reoccurring or sequentially occurring uplink (configured) grant.

In some embodiments, an unused TO (UTO) indicator may indicate that one or more TOs out of a set of TOs referenced/identified (by e.g. a bitmap) are ‘unused’ wherein the TOs out of the set of referenced/identified TOs that are not indicated as ‘unused’ may be considered as being ‘used’ or ‘may be used”.

In some embodiments, the UE may be configured to transmit UTO information to the network in uplink control information (UCI). A UTO-UCI can for example be transmitted using uplink physical signals, using MAC control elements, or using RRC signaling.

In some embodiments, a UTO indicator may be signaled as an index to an RRC configured table. For example, the UE be configured with ConfiguredGrantConfig information element (IE) including a field cg-UTO-List-r1X, which is a sequence of CG-UTO-rX where CG-UTO-rX is defined as shown in Table 3:

TABLE 3
CG-UTO-rX Example

| CG-UTO-rX ::= SEQUENCE { | |
|---|---|
| utoPatternId | UtoPatternId |
| duration-rX | INTEGER (A1..A2), |
| offset-rX | INTEGER (B1..B2) |
| } | |
| UtoPatternId ::= | INTEGER (0..maxNrofUtoPatterns−1) |

In Table 3 above, A1, A2, B1, B2 and maxNrofUtoPatterns are provided by configuration. The values A1 and A2 determine the minimum and maximum of the range values for duration-rX, correspondingly. Similarly, B1 and B2 determine the minimum and maximum of the range values for offset-rX. The parameter value maxNrofUtoPatterns determines the maximum number that can be used by M.

In this embodiment and in other embodiments, the UTO-UCI may comprise the utoPatternId.

The RRC parameters duration-rX and/or offset.rX can be configured as fixed values or determined by default values applicable to a configured grant configuration, or multiple configured grant configurations or all configured grant configurations for a BWP of a serving cell. In another way, different RRC parameters duration-rX and/or offset.rX can be separately configured for a different configured grant if more than one configured grant is configured. This may be useful when a different configured grant is configured in the same UE for different traffic types such that different patterns for unused TOs are needed.

In one example, A1 and B1 can be ‘0’ to indicate a special case where all remaining TOs will be used until the end of predetermined duration, such as the end of period of current configured grant.

It is also possible that duration-rX is only used without offset-rX to differ UtoPatternId given that all unused TOs are applied as soon as UTO-UCI is received.

In another example, offset-rX is only used without duration-rX to differ UtoPatternId given that all TOs after the indicated offset-rX will be unused until the predetermined time such as the end of current period of configured grant.

In some examples, the lowest value for offset-rX may be larger than one.

In some examples, the values of offset-rX can be integer values. Each value can determine a number of slots or number of symbols.

In some examples, the offset-rX references a slot or a symbol after a reference slot, or after a reference symbol. For example, the reference slot may be the slot in which the UTO indicator is transmitted. The reference slot can be determined based on one or more out of:
k symbols or slots after the slot in which the UTO indicator is transmitted, where k is configured by gNB (network node) based on one or more out of:
   a. gNB processing capability such as UCI or UTO-UCI decoding time,
   b. processing time for scheduling,
   c. processing time for PDCCH transmission, e.g., DCI encoding.
k symbols or slots after the slot in which the UTO indicator is transmitted, where k may depend on numerology.
k symbols or slots after the slot in which the UTO indicator is transmitted, where k may depend on UE capability.
the last slot of a configured grant period which includes a CG PUSCH transmission indicating the UTO indicator.
the last slot of a previous radio frame.
the last slot of a previous even indexed or odd-indexed radio frame.
the first slot of the radio frame with the CG PUSCH transmission indicating the UTO indicator.
the first slot of the earliest preceding even-indexed radio frame to the CG PUSCH transmission indicating the UTO indicator.
the first slot of the earliest preceding odd-indexed radio frame to the CG PUSCH transmission indicating the UTO indicator.

For example, the reference symbol can be the last symbol in a PUSCH that includes the UTO indicator is transmitted. In another example, the reference symbol can be the last symbol of the PUSCH that includes UTO. In another example, the reference symbol can be the last symbol of a CG period that includes the PUSCH transmission with UTO. In another example, the reference symbol can be determined based on one or more out of:
k symbols or slots after the last symbol including UTO or the last symbol of a PUSCH including UTO, slot in which the UTO indicator is transmitted, where k is configured by gNB (network node) based on one or more out of
   a. gNB processing capability such as UCI or UTO-UCI decoding time,
   b. processing time for scheduling,
   c. processing time for PDCCH transmission, e.g., DCI encoding.
k symbols or slots after the last symbol including UTO or the last symbol of a PUSCH including UTO, where k may depend on numerology
k symbols or slots after the last symbol including UTO or the last symbol of a PUSCH including UTO, where k may depend on UE capability
the last symbol of a CG period that includes the PUSCH transmission with UTO indicator.
the last symbol of a previous radio frame.
the last symbol of a previous even indexed or odd-indexed radio frame.
the first symbol of the radio frame with the CG PUSCH transmission indicating the UTO indicator.
the first symbol of the earliest preceding even-indexed radio frame to the CG PUSCH transmission indicating the UTO indicator.
the first symbol of the earliest preceding odd-indexed radio frame to the CG PUSCH transmission indicating the UTO indicator.

The procedure for determining UTO of a configured grant would be applicable from a point that is determined from the indicated offset-rX in UTO and would end after a duration that is determined by a value indicated by duration-rX in UTO. The procedure for determining the UTO for a configured grant PUSCH can be one or combination of the following methods:
The configured grant PUSCH transmission occasion that the corresponding transmission duration occurs within the interval determined by offset-rX and duration-rX, is considered as unused PUSCH transmission occasions.
The configured grant PUSCH transmission occasion that starts within the interval determined by offset-rX and duration-rX, is considered as unused PUSCH transmission occasions.
The configured grant PUSCH transmission occasion that ends within the interval determined by offset-rX and duration-rX, is considered as unused PUSCH transmission occasions.
The configured grant PUSCH transmission occasion that starts and ends within the interval determined by offset-rX and duration-rX, is considered as unused PUSCH transmission occasions.

In some examples, the unit is ‘TOs’ and offset-rX and duration-rX are counted in TOs. For example, if the TOs of the configured grant are located in the slots {4, 9, 14, 19, 24, . . . }, k=2 and the UTO indicator is transmitted in slot 4 (TO “index” 0), then the reference slot may be slot 14 (TO “index” 2). If offset-rX=1 and duration-rX=1, then TO “index” 3, i.e. TO in slot 19 is indicated as used and TO “index” 4, i.e. TO in slot 24, as “unused”.

In other examples, the unit for k, offset-rX and duration-rX may be “slot”, “sub-slot” or “symbol”. In further other examples, the unit for k may be symbols while offset-rX and duration-rX may be TOs. For example, k may reference the first symbol after the last symbol of the TO in which the UTO indicator is/was transmitted. If k=14 (symbols) and the UTO indicator was transmitted is slot 4 using all symbols in the slot, then the reference symbol would be the first symbol in slot 6. If the other TOs for the configured grant are located in the slots 9, 14, 19, 24 . . . as in the previous example. If offset-rX is in unit TOs, it may reference the TO index after the reference symbol, i.e. if offset-rX=0 the TO in slot 9 is referenced, offset-rX=1 would reference the TO in slot 14, and so on.

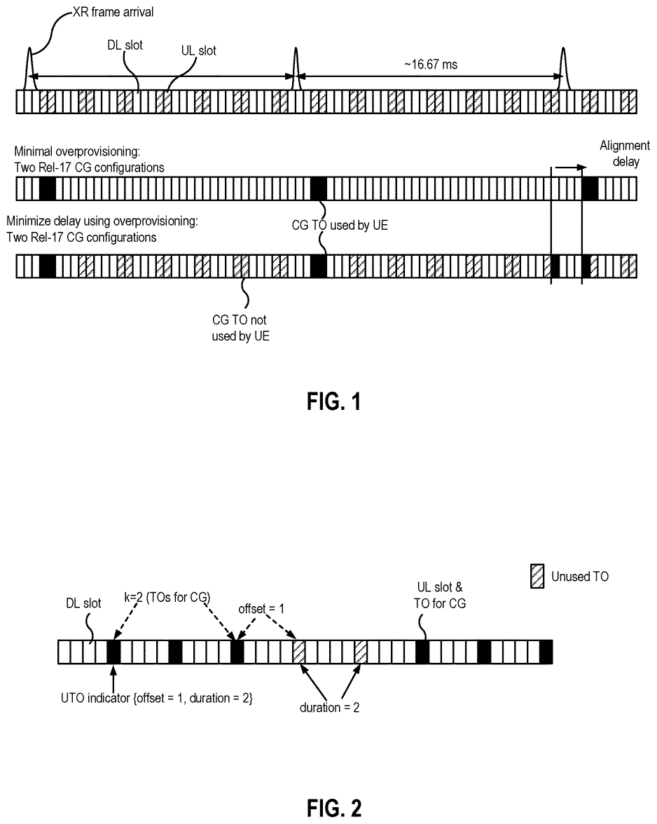

FIG. 2 illustrates an example of signaling of a UTO indicator. As shown therein, a UTO indicator is sent in a UL slot with a reference TO k=2, an offset of 1 and a duration of 2. This indicates that the two TOs following the next two TOs are unused.

In some embodiments, the pattern for unused TOs is defined as a bitmap where a value ‘0’ (or ‘1’) indicates “used TO” while a value ‘1’ (or ‘0’) indicated “unused TO”. For example, CG-UTO-rX may be defined as shown in Table 4 where utoPatternSize is the size of the bitmap.

TABLE 4
CG-UTO-rX Example

| CG-UTO-rX ::= SEQUENCE { | |
|---|---|
| utoPatternId | UtoPatternId |
| utoPattern | BIT STRING (SIZE (utoPatternSize)) |

}

In some examples, the CG-UTO-rX includes a periodicity and length of the pattern as shown in Table 5, where C is an integer and utoPatternLength determines number of valid pattern bits in utoPattern.

TABLE 5
CG-UTO-rX Example

CG-UTO-rX ::= SEQUENCE {

| | |
|---|---|
| utoPatternId | UtoPatternId |
| utoPattern | BIT STRING (SIZE (maxUtoPatternSize)) |
| utoPatternLength | INTEGER (1..C) |

}

In some examples, the utpPatternLength may determine the periodicity in which the pattern recurs. For example, maxUtoPatternSize=10 then the pattern 00111 that recurs with a periodicity 5, i.e. 001110011100111 . . . , can be defined as:

$$utoPattern = ‘ 0011100000 ’$$

$$utoPatternLength = 5$$

In some examples, bits in the bitmap represents slots while in other examples represents symbols, or UL slots or CG TOs.

For example, in a bitmap that represents slots, when the bit(s) indicate ‘1’ (or ‘0’) to indicate ‘unused’ in a bitmap, the corresponding slot(s) or CG TOs or UL slot(s) or symbol(s) to the bit(s) are determined and used in the procedure for determining the UTO for a configured grant PUSCH by one or combination of the following methods:
The configured grant PUSCH transmission occasion that the corresponding transmission duration occurs within the indicated slot(s)/UL slot(s)/symbol(s), is considered as unused PUSCH transmission occasions.
The configured grant PUSCH transmission occasion that the corresponding transmission duration starts within the slot(s))/UL slot(s)/symbol(s), is considered as unused PUSCH transmission occasions.
The configured grant PUSCH transmission occasion that the corresponding transmission duration ends within the slot(s))/UL slot(s)/symbol(s), is considered as unused PUSCH transmission occasions.
The configured grant PUSCH transmission occasion that the corresponding transmission duration starts and ends within the slot(s))/UL slot(s)/symbol(s), is considered as unused PUSCH transmission occasions.

In some embodiments, the UE is configured with a single pattern wherein the transmission of the UTO indicator is implicit, i.e. the UE performs a PUSCH transmission including no UTO-UCI.

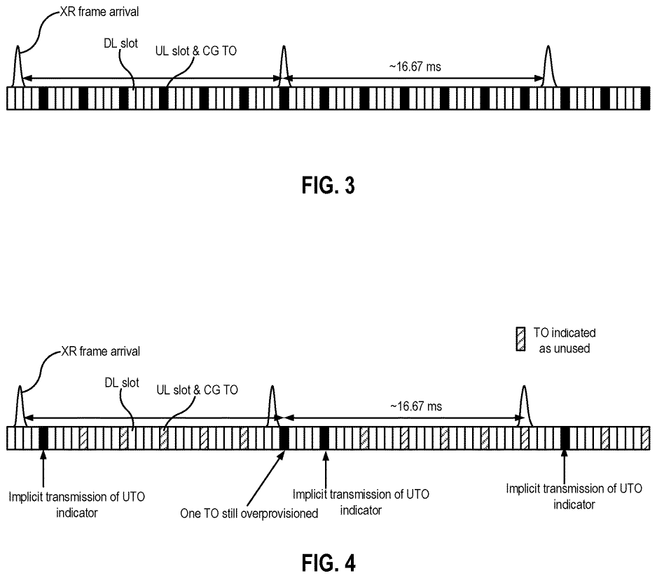

In some embodiments, the gNB defines a pattern for UTOs based on traffic awareness, such as periodicity or packet size distribution of traffic served by CG. For example, the gNB may be aware that the traffic served by CG is XR traffic having a frame periodicity P=~16.67 ms and a frame size distribution D. Thus, the gNB knows that XR frames arrive periodically in the UE UL buffer, but does not know the time offset. That is, the gNB knows that XR frames arrive at times t=t_offset+i·P where i is an integer and where t_offset is unknown. Due to the unknown t_offset, the gNB configures the UE with a CG that is present in every UL slot (e.g., in a TDD carrier with a DDDDU TDD pattern). The situation may look as illustrated in FIG. 3, which is an illustration of XR frame arrival and CG configuration with a TO present in every UL slot on TDD carrier with DDDDU configuration.

The gNB further wants to restrict the UE to utilize more than one TO after a XR frame arrived to enable the gNB to itself decide whether to continue schedule the UE or to utilize the resources for other UEs. Therefore, gNB configures the UE with utoPattern=‘111111 . . . ” and utoPatternLength=5 both representing CG TOs (or UL slots) where the first bit in the utoPattern is the first CG TO after the TO in which the UE sends a PUSCH, and implicitly indicates UTOs as illustrated in FIG. 4, which is an illustration of TOs indicated as unused with implicit indication.

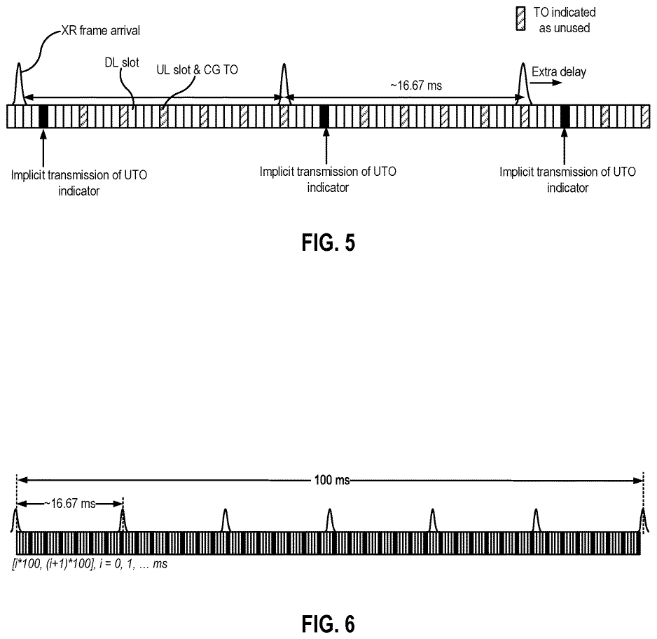

As illustrated in FIG. 4 even though the overprovisioning of TOs is reduced, there is one TO that is still overprovisioned. However, the gNB may choose to reduce/minimize the overprovisioning at cost of increased delay by utoPatternLength=6 as illustrated in FIG. 5, which illustrates TOs indicated as unused with implicit indication where overprovisioning is reduced/minimized.

In some embodiments, the length of the pattern is such it covers the least common multiple (LCM) between the XR frame periodicity and the TO periodicity. Here the LCM is extended to rational numbers where the LCM of r1 and r2 should be the smallest integer divisible (without reminder) by both r1 and r2. For example, with 30 kHz SCS, the slot length is 0.5 ms. With a CG periodicity of 5 slots (2.5 ms) and XR frame periodicity of 1/60*1000 ms, the least common multiple of 2.5 ms and 1/60*1000 ms is equal to 100 ms. With the utoPattern referencing CG TOs, the length of pattern may consist of 100/2.5=40 bits that cover all possibilities XR frame arrival relative to a CG TO, since the arrivals of XR frames relative to CG TOs recur every 100 ms as illustrated in FIG. 6. That is, FIG. 6 is an illustration of periodic XR frame arrivals relative to periodic CG TOs.

In some embodiments, the CG covers multiple TOs per period. For example, on a TDD carrier with TDD pattern DDDUU a multi-TO (multi-PUSCH) CG with periodicity 5 slots may be utilized to have a CG TO present in every UL slot. In such embodiments, the UE may be configured with a single UTO pattern utoPattern=‘0111111 . . . ’ and utoPatternLength=5 (or 6), where the UTO indicator is implicitly transmitted. Again, the first bit in the utoPattern is the first CG TO after the TO in which the UE sends a PUSCH and implicitly indicates UTO.

In another example, the UE may be configured with two UTO patterns, e.g.:
UTO pattern 1: {utoPattern=‘0111111 . . . ’, utoPatternLength=5}, and
UTO pattern 2: {utoPattern=‘0011111 . . . ’, utoPatternLength=5}
   The UE may explicitly transmit an indicator indicating either UTO pattern 1 or 2.

In some embodiments, if the UE transmits a UTO indicator indicating that a TO is a used TO, then UE shall transmit a PUSCH on the TO. In other embodiments, the UE is allowed to transmit or not transmit a PUSCH on the TO if the TO is indicated as being a used TO.

In some embodiments, the UE transmits a UTO indicator indicating which TOs may be used for transmission from a set of TOs that were previously indicated as unused.

In some embodiments, the UE transmits UTO indicator indicating which TOs the UE needs from a set of deactivated TOs. Furthermore, two scenarios or options may be considered, and depending on the option, the term ‘deactivated’ is explained respectively.

In one option, a second UTO indicator may be sent/transmitted to override a previous/last UTO indicator. For example, the UE may send a UTO indicator indicating TOs that will not be used (“deactivated TOs”). The UE may subsequently decide that it needs to use one or more of the deactivated TOs. The UE may then send a new UTO indicating that it wants to use one or more of the ‘deactivated’ TOs. There can be a restriction that the new UTO indicator must be sent within a given time window with respect to the previous UTO indicator in order to override the indication sent in the previous UTO indicator. For example, a timer may be triggered when a UTO indicator is transmitted, and the UE may have the possibility to override the UTO indicator with a new UTO indicator before the timer expires.

In another option, a second UTO indicator may not override a previous UTO indicator. Rather, the second UTO indicator may indicate which or how many TOs the UE needs in order to transmit data. For example, assume that in a CG period with 4 TOs, current data packets are arriving require more than 4 TOs per period (e.g., 6 TOs per period). The UE can indicate in the UTO indicator that it needs more TOs than are currently allocated. The UE could either indicate the difference between the number of TOs needed and the number allocated, i.e., 6−4=2 TOs, or the UE could indicate the total number of TOs required in the period, i.e., 6 TOs.

In some embodiments, one or more of the following restrictions can be applied:
Applied to multi-PUSCH/Multi-TO CG, e.g., possibly configured with parameter TimeDomainAllocationListForMultiPUSCH
Specific CG, e.g., type 1 or 2
Tied to specific use case, such as XR characterized by higher layer parameters, for instance, XR user assistance information (UAI)
The unused TO indication/signaling is not considered if cg-RetransmissionTimer is configured

In the embodiments described above, TOs are described as “used” or “unused” in the UTO indicator. However, this does not exclude other states for the TOs. For example, a TO may be indicated as being in one of three states: “used”, “unused” and “may be used,” where “may be used” indicates that the UE has not yet decided if the UE needs to use the TO or not. The UE behavior for this “may be used” state can, for example, be that the UE will use a TO if the UE has data to transmit and the UE does not use the TO if the UE do not have data to transmit (similar to the way skip uplink works). The embodiments above for indicating a used or unused TO may be combined, for example, such that a first indicator is used for indicating unused TOs and a second indicator is used to indicate “may be used” TOs (for example by making UTO-UCI contain two utoPatternId, one for used TOs and one for “may be used” TOs). Or the patterns may be extended to indicate more information. For example CG-UTO-rX may be extended to indicate two sets, for example “used” TOs and “may be used” TOs, as shown in Table 6.

TABLE 6
CG-UTO-rX Example

| CG-UTO-rX ::= SEQUENCE { | | |
|---|---|---|
| utoPatternId | UtoPatternId | |
| unusedDuration-rX | INTEGER (A1..A2), | |
| unusedOffset-rX | INTEGER (B1..B2), | |
| mayUseDuration-rX | INTEGER (A3..A4), | OPTIONAL |
| mayUseOffset-rX | INTEGER (B3..B4) | OPTIONAL |

}

In Table 6, unusedDuration-rX and unusedOffset-rX are defined and used similar as duration-rX and offset-rX to indicate unused TOs, while i and mayUseOffset-rX are defined and used as duration-rX and offset-rX to indicate “may be used” TOs, and where A3 and A4 are defined similar as A1 and A2, and B3 and B4 are defined similar as B1 and B2.

The UE may be configured with which state the UE is allowed to indicate, or which state the UE must indicate (for example, the UE is allowed to indicate “may be used” TOs and the UE must indicate “unused” TOs).

In some embodiments the UTO information (e.g., the UTO pattern) may be specific to a configured grant configuration. That is, the UE may be configured with multiple configured grant configurations (multiple CG instances) where each CG instance may independently be configured with UTO patterns. For example, for CG instance A, the UE is not configured with a UTO pattern and will not transmit a UTO indicator for CG TOs for CG instance A, while the UE may be configured with UTO patterns for CG instance B.

In some embodiments the UTO pattern is common for a set of CG instances. In some such embodiments, the UE may be configured with multiple sets of set of UTO patterns where each set of UTO patterns is assigned a utoPatternSetId. The ConfiguredGrantConfig for a CG instance may include a utoPatternSetId field indicating the set of UTO patterns UE shall use for the CG instance.

In some embodiments, every CG PUSCH is configured to include UTO-UCI, and if a UE transmits such PUSCH, the PUSCH includes UTO-UCI as UCI. Hence, the gNB can always decode such PUSCH assuming UTO-UCI is always present. In other words, if a UE transmits a transport block (TB) including data and/or other control information in a PUSCH, the UE must include UTO-UCI in the PUSCH as well. If there is no data to transmit on PUSCH, then UE does not transmit over the PUSCH (including the UTO-UCI).

In other embodiments, the UE is only allowed to transmit a UTO indicator (UTO-UCI) at pre-determined PUSCHs/occasions or configured occasions. For example, the UE may transmit a UTO indicator in every second, third, etc. occasion, where the UE can send PUSCH with the configured grant. In another example, the UE transmits a UTO indicator in every second, third, etc., PUSCH transmitted with configured grant.

In another example, the UTO-UCI occasions can be configured with some periodicity which can be the same or different from the CG periodicity. In only those CG occasions overlapping with the UTO-UCI occasions can the UE transmit a TB and UTO-UCI in CG PUSCH. Hence, the gNB will expect in such occasions to receive UTO-UCI and TB (not just TB only) multiplexed in the PUSCH and try to decode accordingly. As with previous embodiments, if there a no TB to transmit, the UE will not transmit UTO-UCI on such CG occasions.

In another embodiment, the PUSCHs are configured to include UTO-UCI, but some rules are applied where the UE includes UTO-UCI in the specific transmission(s). One example is that the UE always includes UTO-UCI in the first transmission, but not in remaining transmissions in a CG period with multiple PUSCHs. Elaborating the example, if there is a CG multi-PUSCH with 6 PUSCHs per period (within the CG periodicity), and wherever UE beings its first transmission in these 6 PUSCHs, the UE transmits its first transmission in 3rd PUSCH (and remaining transmissions on 4th and 5th PUSCH), then the UE must include UTO-UCI only in 3rd PUSCH but not in 4th and 5th PUSCH.

In another embodiment, the UE is configured to transmit a TB with or without UTO-UCI multiplexed on the PUSCH. The UE can decide whether to transmit UTO-UCI or not. This has the highest cost in terms of blind decoding at the gNB side, as the gNB may require to decode same PUSCH with both options with PUSCH having TB and UTO-UCI, or only TB (without UTO-UCI).

In further other embodiments, the UE may transmit a UTO indicator in any PUSCH transmitted with a configured grant. In some embodiments, the UE may transmit a first UTO indicator with a first PUSCH with configured grant and may transmit a second UTO indictor with a second PUSCH with configured, where first and second PUSCH are different PUSCHs. However, TOs indicated as ‘unused’ by the first indicator and referenced by the second indicator are also indicated as ‘unused’ by second indicator. For example, the first indicator may be transmitted in slot 4 and reference TOs in slots {9, 14, 19} and indicate TOs in slots {14, 19} as ‘unused,’ while the second indicator may be transmitted in slot 9 and reference TOs in slots {14, 19, 24} and indicate TOs {19, 24} as ‘unused’.

Pre-determined or configured TOs may be every TO, every second TO, etc., of the configured grant.

In some embodiments, the UTO indicator may indicate one or more TOs out of a set of TOs referenced/identified (by e.g. a bitmap) as ‘unused.’ The TOs out of the set of referenced/identified TOs not indicated as ‘unused’ may be considered as ‘used’ or ‘may be used”.

In some embodiments, the UTO indicator may indicate that no TOs are unused. For example, a bit with all ‘0’ may indicate that no TOs are unused.

In some embodiments, when bits for the UTO indicator are always included in CG PUSCH, one value for the UTO indicator is reserved to indicate that bits for UTO indicator do not carry any information of unused TOs. For example, the first or last index of an RRC configured table could be reserved for indicating “no UTO information present.”

In further other embodiments, bits for the UTO indicator are always included in CG PUSCH if number of patterns configured is lower than a threshold.

In further other embodiments, UE may be configured with <always include UTO bits> to always include bits for UTO indicator in CG PUSCH. If the UE is not configured with <always include UTO bits>, then the bit for the UTO indicator is present if the UTO indicator is transmitted.

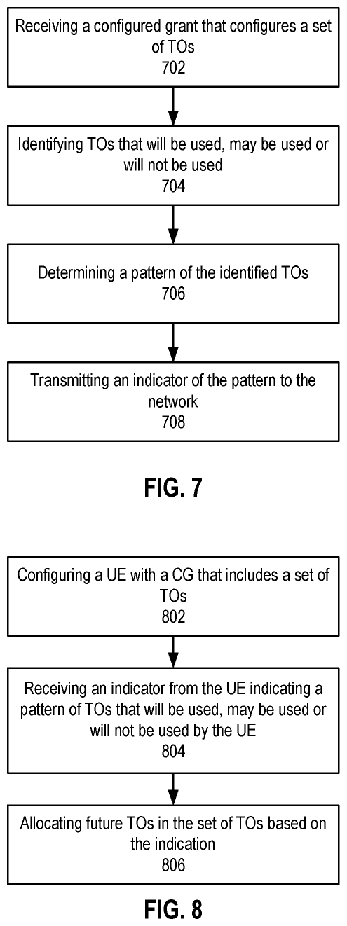

Operations of a UE according to some embodiments are illustrated in FIG. 7. Referring to FIG. 7, a method performed by a user equipment, UE, in a wireless communication network includes receiving, from the wireless communication network, a configured grant that configures the UE with the set of transmission occasions for performing uplink transmission (block 702) and identifying transmission occasions, within the set of transmission occasions, that will all be used, may be used, or will not be used, by the UE to perform uplink transmission (block 704). The method further includes determining a pattern of the identified transmission occasions (block 706), and transmitting, to the wireless communication network, an indicator that indicates the pattern of the identified transmission occasions (block 708).

The set of transmission occasions may include a set of periodically repeating transmission occasions, and wherein the pattern of transmission occasions may include a periodically repeating subset of the set transmission occasions.

In some embodiments, the indicator may include a bitmap of the identified transmission occasions.

In some embodiments, the indicator may include a parameter associated with the pattern of the identified transmission occasions.

The parameter may include at least one of a starting time of the pattern, an offset that defines the starting time of the pattern, a duration of the pattern, and/or a periodicity of the pattern.

The method may further include determining a plurality of patterns of the identified transmission occasions, wherein the indicator indicates the plurality of patterns of the identified transmission occasions.

The subset of transmission occasions may be determined based on an expected need for a periodically repeating uplink transmission requirement by a service operated by the UE.

The service operated by the UE may include an extended reality, XR, service, and wherein the periodically repeating uplink transmission requirement may include a requirement to perform uplink transmission of XR frames at a predetermined frame rate.

The method may further include may further include performing a physical layer procedure based on the identified subset of transmission occasions.

The subset of transmission occasions may include transmission occasions in which the UE will not perform uplink transmission.

The method may further include refraining from performing uplink transmission during the subset of transmission occasions.

The subset of transmission occasions may include only those transmission occasions in the set of transmission occasions in which the UE will perform uplink transmission.

The method may further include refraining from performing uplink transmission during the transmission occasions in the set of transmission occasions other than transmission occasions in the subset of transmission occasions.

The method may further include receiving, from the wireless communication network, a confirmation of the indicator.

Transmitting the indicator to the wireless communication network may include transmitting the indicator in a UCI message.

The pattern may include a set of symbols, slots, sub-slots or TOs such that a sub-set of transmission occasions is identified/referenced.

The patten may indicate an identified transmission occasion as ‘unused’, ‘used’ or ‘may be used’.

The indicator that indicates the pattern of the identified subset of transmission occasions may be an unused transmission occasion, UTO, indicator, and the method may further include triggering, by a MAC layer, a lower layer to transmit a first UTO indicator when delivering a first MAC PDU for a TO, and triggering, by the MAC layer, the lower layer to transmit a second UTO indicator when delivering a second MAC PDU for a second TO, where the first and second TOs are different TOs.

The TOs that are indicated by the first UTO indicator as being ‘unused’ and referenced by second UTO indicator may also be indicated by second indicator as being ‘unused’.

In some embodiments, the indicator identifies transmission occasions within the subset of transmission occasions based on an offset from a slot that is part of the configured grant.

The method may further include triggering a physical, PHY, layer in the UE to perform transmission of the indicator. Triggering of the PHY layer to perform transmission of the indicator may be performed when the UE delivers a MAC PDU to a lower layer, or may be performed at a transmission occasion in the set of transmission occasions.

Operations of a network node according to some embodiments are illustrated in FIG. 8. Referring to FIG. 8, a method performed by a network node of a wireless communication network includes configuring a user equipment, UE, with a configured grant that configures the UE with a set of transmission occasions for performing uplink transmission (block 802), and receiving an indicator from the UE indicating a pattern of transmission occasions in the set of transmission occasions that are configured for the UE for performing uplink transmission (block 804). The pattern of transmission occasions corresponds to transmission occasions, within the set of transmission occasions, that will all be used, or not used, by the UE to perform uplink transmission. The method further includes allocating future transmission occasions in the set of transmission occasions based on the indicator (block 806).

The set of transmission occasions may include a set of periodically repeating transmission occasions, and wherein the pattern of transmission occasions may include a periodically repeating subset of the set transmission occasions.

The indicator may include a bitmap of the identified transmission occasions.

The indicator may include a parameter associated with the identified transmission occasions.

The parameter may include at least one of a starting time of the pattern, an offset that defines the starting time of the pattern, a duration of the pattern, and/or a periodicity of the pattern.

The method may further include determining a plurality of patterns of the identified transmission occasions, wherein the indicator indicates the plurality of patterns of the identified transmission occasions.

The method may further include transmitting an acknowledgement message to the UE acknowledging the indicator in response to receiving the indicator.

The indicator may indicate that the subset of the set of transmission occasions will not be used by the UE for performing uplink transmission, and the method may further include re-allocating a transmission occasion in the subset of the set of transmission occasions to another UE.

The indicator may indicate that only the subset of the set of transmission occasions will be used by the UE for performing uplink transmission, and the method may further include re-allocating transmission occasions in the set of transmission occasions, other than those transmission occasions in the subset of the set of transmission occasions, to another UE.

The pattern may include a set of symbols, slots, sub-slots or TOs such that a sub-set of transmission occasions is identified/referenced.

The pattern may indicate an identified transmission occasion as ‘unused’, ‘used’ or ‘may be used’.

In some embodiments, the method performed by UE is performed together by the PHY and MAC layers, and may also include information from other layers such as radio link control (RLC) and/or packet data convergence protocol (PDCP) layers.

In such embodiments, the MAC layer may perform the following functionalities.

The MAC layer may obtain a subset, or a set of subsets, of a group of TOs, such as from an RRC configuration.

The group of TOs can be understood as being all or a subset of TOs belonging to one period of a CG, or all or a subset of TOs belonging to more than one period of a CG. For example, each CG period may be allocated with 4 TOs, where a group/plurality of TOs is defined by associating TOs from 2 consecutive periods, i.e., 8 TOs form a group.

The MAC layer may select one or more subsets of TOs, where a selected subset is a set of TOs that are to be unused TOs (or used or “may be used”, or any combination of these).

The subset of TOs may be selected such that the number of unused TOs among the remaining used TOs shall be minimized, or equivalently, the number used TOs among TOs not indicated as unused shall be maximized.

The UE may use knowledge about buffer size, expected arrival and size of data, the delay budget for delivering the data, etc., to select the subset or subsets of TOs. For example, based on current buffer size and TB size per TO, the UE may determine which TOs would not be needed to empty the buffer.

The buffer size may include information from the RLC layer and/or the PDCP layer, including header size as well as PHY control information, such as UCI which require resources for uplink transmissions.

The MAC layer may perform the selection based on information provided by an upper layer, such as the RRC layer. The upper layer may provide the MAC layer with information regarding traffic periodicity, jitter information, distribution of size of data “burst”, etc.

The selected subset of TOs may be indicated to the MAC by an upper layer.

The PHY layer may determine the selected subset of TOs, and the MAC layer may be aware (by UE implementation or indication from the PHY layer) of the selection performed by the PHY layer.

The UE may be configured with constraints for the selection of subsets of TOs. For example, if the TOs are grouped in time, the UE may only select a certain percentage (or a maximum percentage) of used TOs per time unit, or a certain number (or a maximum number) of used TOs per the periodicity of the ConfiguredGrantConfig IE. In this case, the UE may select the best subset of TOs that fulfills the constraint.

The UE may be configured with a time interval as a timeline requirement for indicating unused TOs. The UE may be expected to report the unused TOs not later than the required timeline before the start of the first unused TOs.

The value of the required timeline can depend on the gNB implementation, the numerology of the cell with configured grant, and/or the UE capability.

The UE may be configured to reselect a subset of TOs within a certain time interval. For example, the UE may be configured to reselect the subset of TOs once every periodicity of the ConfiguredGrantConfig, or at expiry of a timer.

The UE may indicate the selection in the first used TO after the reselection.

The UE can also add extra required TOs for potential transmissions as a margin which can be configured by the network. The extra TOs would be not reported as ‘unused’, although it may not be used but may be saved for potential retransmissions or new traffic arrival during a current configured grant period.

The PHY layer may be triggered to perform transmission of an indicator indicating the obtained subset of TOs to the network node. The triggering may occur every time the UE delivers a MAC PDU (i.e., a TB) to a lower layer or at pre-determined or configured TOs of the configured grant. In such examples, the MAC layer may trigger a lower layer to transmit a first indicator when delivering a first MAC PDU for a first TO and then trigger the lower layer to transmit a second indictor when delivering a second MAC PDU for a second TO, where the first and second TOs are different TOs. The TOs that are indicated by the first indicator as ‘unused’ and referenced by second indicator are also indicated by second indicator as ‘unused’.

For example, the first indicator may be transmitted in slot 4 and reference TOs in slots {9, 14, 19} and indicate TOs in slots {14, 19} as ‘unused’ while second indicator may be transmitted in slot 9 and reference TOs in slots {14, 19, 24} and indicate {19, 24} as ‘unused’.

Pre-determined or configured TOs may be every TO, every second TO, etc., of the configured grant.

Pre-determined or configured TOs may be every TO, every second TO, etc., of the configured grant in which the UE transmits a PUSCH with configured grant.

The triggering may occur any time the UE delivers a MAC PDU (TB) to a lower layer. As in above example, the MAC layer may trigger the lower layer to transmit a first indicator when delivering a first MAC PDU for a first TO and then trigger the lower layer to transmit a second indictor when delivering a second MAC PDU for a second TO, where the first and second TOs are different TOs. The TOs that are indicated by the first indicator as ‘unused’ and referenced by second indicator are also indicated by second indicator as ‘unused’.

For a TO of the plurality of TOs if the grant corresponding the TO is indicated as an unused TO, then the MAC layer may consider the grant as invalid or not present. The MAC procedures for delivery of the grant to a HARQ entity may include a prevention such that the grant is not delivered to HARQ entity.

For example, the MAC specification may include a provision as shown in Table 7 below:

TABLE 7
MAC Specification

For each Serving Cell and each configured uplink grant, if configured and , activated and the
PUSCH duration of this configured grant is not a un-used PUSCH duration, the MAC entity
shall:
/* omitted part */
4> deliver the configured uplink grant and the associated HARQ information to the
HARQ entity.
/* omitted part */

The above intention to not deliver the uplink configured grant to the HARQ entity can be formulated in various ways, such as shown in Table 8:

TABLE 8
MAC Specification

“For each Serving Cell and each configured uplink grant, if configured and , activated and is
not indicated as un-used, the MAC entity shall:
/* omitted part */
4> deliver the configured uplink grant and the associated HARQ information to the
HARQ entity.
/* omitted part */

As another example, the MAC specification may contain a limit in the section 5.8.2 of 3GPP TS 38.321 v17.3.0 such that there is no reoccurrence for the unused TOs as shown in Table 9:

TABLE 9
MAC Specification

Upon configuration of a configured grant Type 1 for a BWP of a Serving Cell by upper layers,
the MAC entity shall:

| | |
|---|---|
| 1> | store the uplink grant provided by upper layers as a configured uplink grant for the |

indicated BWP of the Serving Cell;

| | |
|---|---|
| 1> | 27nitialize or re-initialise the configured uplink grant to start in the symbol according to |

timeDomainOffset, timeReferenceSFN, and S (derived from SLIV or provided by startSymbol
as specified in TS 38.214 [7]), and to reoccur with periodicity.

| | |
|---|---|
| 2> | if a reoccurrence for a PUSCH duration of a configured grant would correspond to |

a PUSCH duration selected to be unused, then the configured grant is considered to not
reoccur for that PUSCH duration.

The above intention can be formulated in various ways, such as shown in Table 10:

TABLE 10
MAC Specification

Upon configuration of a configured grant Type 1 for a BWP of a Serving Cell by upper layers,
the MAC entity shall:
1> store the uplink grant provided by upper layers as a configured uplink grant for the
indicated BWP of the Serving Cell;
1> 27nitialize or re-initialise the configured uplink grant to start in the symbol according to
timeDomainOffset, timeReferenceSFN, and S (derived from SLIV or provided by startSymbol
as specified in TS 38.214 [7]), and to reoccur with periodicity in the reoccurances not
indicated as unused.

In one example for Type 2 configured grant, section 5.8.2 of 3GPP TS 38.321 v17.3.0 may indicate limitations for the sequentially occurrences as shown in Table 11:

TABLE 11
MAC Specification

```
After an uplink grant is configured for a configured grant Type 2, the MAC entity shall
consider sequentially that the Nth (N >= 0) uplink grant not indicated as unused occurs in
the symbol for which:
  [(SFN × numberOfSlotsPerFrame × numberOfSymbolsPerSlot)
  + (slot number in the frame × numberOfSymbolsPerSlot) + symbol number in the slot] =
  [(SFNstart time × numberOfSlotsPerFrame × numberOfSymbolsPerSlot
  + slotstart time × numberOfSymbolsPerSlot + symbolstart time) + N × periodicity]
modulo (1024 × numberOfSlotsPerFrame × numberOfSymbolsPerSlot)
where SFNstart time, slotstart time, and symbolstart time are the SFN, slot, and symbol,
respectively, of the first transmission opportunity of PUSCH where the configured uplink
grant was (re-)initialised.
```

The MAC layer may prevent building a MAC PDU and delivery to the PHY layer in procedures. For example, Section 5.4.3.1.3, of 3GPP TS 38.321 v17.3.0 may include the procedure shown in Table 12:

TABLE 12
MAC Specification

The MAC entity shall:

| | |
|---|---|
| 1> | if the MAC entity is configured with <usedTosIndicator> and the grant indicated to the |

HARQ entity is a configured uplink grant and the PUSCH duration is an unused PUSCH
duration:

| | |
|---|---|
| 2> | not generate a MAC PDU for the HARQ entity |

The above intention to not generate a MAC PDU may be formulated in various ways, e.g.

| | |
|---|---|
| 1> | if the MAC entity is configured with <usedTosIndicator> and the grant indicated to the |

HARQ entity is a configured uplink grant indicated as unused:

| | |
|---|---|
| 2> | not generate a MAC PDU for the HARQ entity |

In some examples, the UE may be configured to generate a MAC PDU for an unused PUSCH if certain conditions are fulfilled. Those certain conditions may be one or more of:
There is UCI to be multiplexed on the PUSCH;
There is UCI comprising HARQ-ACK with high priority index;
If the MAC PDU would include a specific MAC CE with periodic BSR and there is data available for a LCG, or periodic or a-periodic indication of traffic awareness information, e.g. jitter, data size distribution.

In one embodiment, the MAC selection of indicator is “triggered” by a higher layer in order to indicate the TOs that the MAC layer will determine will be unused.

In one embodiment, the UE may apply the above MAC procedure only if the PHY layer has the capability to incorporate an indicator in the used TO (e.g., multiplexed with PUSCH sent on TO).

### Indicator Transmission Rules

In some embodiments, the UE is configured to perform transmission of the indicator in the first TO that is used for transmission after expiration of a timer, such as unusedTosIndicatorTimer. If the timer is not running and a TO is used for transmission, then UE starts the timer and UE performs transmission of the indicator.

In some embodiments, the UE is configured to perform transmission of the indicator in the first used TO of the plurality of TOs, where said TO do not belong to the set of TOs associated with previous transmitted indicator

In some embodiments, the UE is configured to perform transmission of the indicator in the first used TO after at least one unused TO associated with the last transmitted indicator.

In some embodiments, the UE is configured to perform transmission of the indicator in every used TO.

In some embodiments, the UE is configured to perform transmission of the indicator in designated TOs based on some patterns, or in specific slots or symbols as per configured by network/gNB using CG activation DCI or RRC configuration.

In a non-limiting embodiment when UE is configured to perform transmission of the indicator based on a timer, e.g. unusedTosIndicatorTimer, the MAC specification may include a sentence as shown in Table 13.

TABLE 13
MAC Specification

For each configured and activated configured uplink grant configured with
unusedTosIndicatorTimer and the unusedTosIndicatorTimer is not running, the UE
implementation selects a subset of the PUSCH durations of the configured uplink grant
among the subsets configured by higher layers and
triggers lower layer to transmit <indicatorName> associated with selected subset in first
PUSCH duration that MAC delivers a TB to lower layer and start unusedTosIndicatorTimer
store PUSCH durations associated with selected subset of PUSCH durations as un-used/in-
valid

The above intention may again be formulated in various ways, such as shown in Table 14:

TABLE 14
MAC Specification

For each configured and activated configured uplink grant configured with
unusedTosIndicatorTimer and the unusedTosIndicatorTimer is not running, the UE
implementation selects a subset of the reoccurences of the configured uplink grant
among the subsets configured by higher layers and
triggers lower layer to transmit <indicatorName> associated with selected subset and
start unusedTosIndicatorTimer
store reoccurring configured uplink grants associated with selected subset of
reoccurences of the configured grant as unused/invalid

In one alternative formulation the indicated unused TOs is considered as non-occurring:

TABLE 15
MAC Specification

For each configured and activated configured uplink grant configured with
unusedTosIndicatorTimer and the unusedTosIndicatorTimer is not running, the UE
implementation selects a subset of the reoccurences of the configured uplink grant among
the subsets configured by higher layers and
triggers lower layer to transmit <indicatorName> associated with selected subset and start
unusedTosIndicatorTimer
consider configured uplink grants sequentially occurring as specified in clause 5.8.2
associated with selected subset of reoccurences as non-occurring

In another embodiment, a UE transmits the indicator as soon as all of data in current buffer is transmitted but there are still unused TOs. It is also possible that a UE can wait for additional time although all data has been transmitted since there might be a retransmission needed. For this, a UE can further consider cg-RetransmissionTimer of all transmitted data in current buffer. For example, when the last bit in current buffer is transmitted, a UE will check the cg-RetransmissionTimer of all HARQ processes, and it indicates unused TOs only when some or all of cg-RetransmissionTimers are expired. Instead of cg-RetransmissionTimer, a network can introduce a new indicationWaitTimer which makes the UE wait for extra time after all data in current buffer is transmitted. This timer is a common timer to be applied to all HARQ processes in the corresponding UE. The timer will start when all data is transmitted at least one time and will be stopped in a predetermined timing value. Once the timer is expired, a UE will indicate unused TOs if there are any remaining TOs.

In some embodiments, the UE is configured with maxNrofUsedTOs such that obtained one sub-set comprises at most maxNrofUsedTOs consecutive used TOs. In a similar embodiment, the UE may be configured with a set of subsets of TOs such that no single subset of TOs includes more than 2 TOs. For example, let the plurality of TOs be the slots {4, 9, 14, 19, 24, 29, . . . }, maxNrofUsedTOs=2, and let the UE be configured with a timer that expires after 11 slots, then if data is available at slot 4, then UE transmits the indicator and starts timer and the indicated unused TOs may be {9, 14} or {14}. At slot 14, the timer is running and the TO has been indicated as unused. The UE does not perform a transmission in slot 14. For the TO at slot 19, the timer has expired, and the UE may again transmit the indicator. That is, if data is available, the UE transmits the indicator and starts timer and the indicated unused TOs may be {19, 24} or {24}.

In some embodiments, the obtained plurality of TOs is determined from TOs defined by a configured grant Type 1 or Type 2 configuration.

In some embodiments, if the UE transmitted an indicator indicating a subset of a plurality of TOs, then UE must also receive a confirmation message before the subset of the plurality of TOs may be used by the UE. For example, the transmitted indicator be a preferred subset of the plurality of TOs which the gNB shall confirm to be allowed to be used by the UE.

In a second example, the UE first transmits an indicator indicating a first subset of plurality of TOs, then the UE starts using first subset of the plurality of TOs but discovers that a second subset of the plurality of TOs is preferred. The UE then transmits an indicator indicating the second subset of the plurality of TOs, but continues to only use TOs that belong to first subset until a confirmation message is received. In some examples, the confirmation message is an explicit message, such as a MAC control element (CE) indicating “confirm”, or reactivation of the configured grant. In some examples, UE may receive an indicator (e.g., a MAC CE) indicating a third subset of plurality of TOs. In such examples, UE then may only continue to use TOs corresponding the TOs associated with the indicated third subset.

In some embodiments, the UE may obtain a first set of plurality of TOs from a first activation DCI of a configured grant configuration, transmitted a first indicator indicating a first subset of plurality of TO and then receive a second activation DCI of same configured grant configuration indicating a second set of plurality of TOs:

The UE may stop using first subset of plurality of TOs (stop timer, if running, when to transmit indicator), and perform a reselection of the second subset of the plurality of TOs,

The UE may continue to use first subset of the plurality of TOs if there are no (future) TOs in the first or second subsets of the plurality of TOs that do not at least partly overlap with no (future) TO in the second or first subsets of the plurality of TOs. For example, the UE may continue to use the first subset of the plurality of TOs if the gNB performs a reactivation of the CG without changing the time locations for the TOs of the CG. This may be desired if the gNB just wants to update the MCS or a frequency-domain allocation, for example.

In other examples, different restrictions on the first and second subsets of the plurality of TOs my apply, for example, that the first and second subsets of TOs fully overlap in time, fully or partly overlap in frequency, MCS, pre-coding, etc. For example, the UE may continue to use the first subset of the plurality of TOs only if reactivation of the CG only changes the modulation and coding scheme (MCS) and/or the precoder.

In further other examples, the UE may continue to use the first subset of the plurality of TOs if reactivation of the CG is using a cell specific radio network temporary identity (CS-RNTI) different from the CS-RNTI used to activate the CG. In further examples, reactivation where the UE continues to use first subset of the plurality of TOs may differentiated from reactivation where the UE does not continue to use first subset of the plurality of TOs based on different field combinations in an activation DCI, e.g. redundancy versions set to all ‘0’ or all ‘1’.

### Division of Methods Between Layers

In some embodiments, some methods described above may be performed at least partly in other layers or in a processing unit. This implies that information needed for the methods may need to be transferred to where the method is performed. For example, the step of “obtaining of a selected subset of the plurality of TOs” may be performed by the MAC layer alone, or the MAC layer may receive an indication of the selected subset of the plurality of TOs from an upper layer (e.g. RRC, RLC or PDCP) or even from a lower layer (e.g., PHY). In some examples, the MAC layer may refrain delivering the grant to a HARQ entity, obtaining a MAC PDU or refrain from delivering a TB to PHY for unused TOs. In another example, the PHY layer may determine the selected sub-set of plurality of TOs and the MAC layer may know by UE implementation or by an indication from the PHY layer which TOs the MAC layer shall refrain from using.

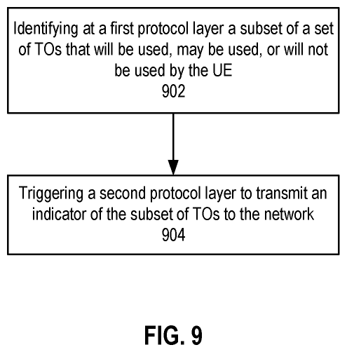

Operations of a UE according to some embodiments are illustrated in FIG. 9. Referring to FIG. 9, a method performed by a user equipment, UE, in a wireless communication network includes identifying, at a first protocol layer of the UE, a subset of a set of transmission occasions that are configured for the UE for performing uplink transmission (block 902). The subset of transmission occasions corresponds to transmission occasions, within the set of transmission occasions, that will all be used, may be used, or will not used, by the UE to perform uplink transmission. The method further includes triggering by a second protocol layer of the UE, that is lower than the first layer, transmission to the wireless communication network of an indicator that indicates the identified subset of transmission occasions (block 904).

The first protocol layer may include a medium access control, MAC, protocol layer, and wherein the second protocol layer may include a physical, PHY, protocol layer.

The method may further include receiving information from a third protocol layer that is higher than the first protocol layer, and using the information to identify the subset of the set of transmission occasions.

The information may include information regarding traffic that is expected to be transmitted using the subset of the set of transmission occasions.

The information may include information relating to traffic periodicity, jitter, and/or data size of the traffic that is expected to be transmitted using the subset of the set of transmission occasions.

The set of transmission occasions may include a set of periodically repeating transmission occasions, and wherein the subset of the set of transmission occasions may include a periodically repeating subset of the set transmission occasions.

The subset of transmission occasions is determined based on an expected need for a periodically repeating uplink transmission requirement by a service operated by the UE.

The service operated by the UE may include an extended reality, XR, service, and wherein the periodically repeating uplink transmission requirement may include a requirement to perform uplink transmission of XR frames at a predetermined frame rate.

The method may further include performing a physical layer procedure based on the identified subset of transmission occasions.

Performing the physical layer procedure based on the identified subset of transmission occasions may include determining a timing condition, and/or determining a slot format indicator restriction based on the identified subset of transmission occasions.

Determining the timing condition may include determining a timing condition for a dynamically scheduled PUSCH transmission based on the indicator.

In some embodiments, the UE can expect a slot format indicator to indicate a set of symbols of a slot, that is indicated by the indicator as being unused by the UE for uplink transmission, as being a downlink or flexible slot.

The subset of transmission occasions may include transmission occasions in which the UE will not perform uplink transmission.

The method may further include refraining from performing uplink transmission during the subset of transmission occasions.

The subset of transmission occasions may include transmission occasions in which the UE will perform uplink transmission.

The method may further include refraining from performing uplink transmission during the transmission occasions in the set of transmission occasions other than transmission occasions in the subset of transmission occasions.

The method may further include receiving, from the wireless communication network, a configured grant that configures the UE with the set of transmission occasions for performing uplink transmission.

The method may further include receiving, from the wireless communication network, a confirmation of the indicator.

Transmitting the indicator to the wireless communication network may include transmitting the indicator in a UCI message.

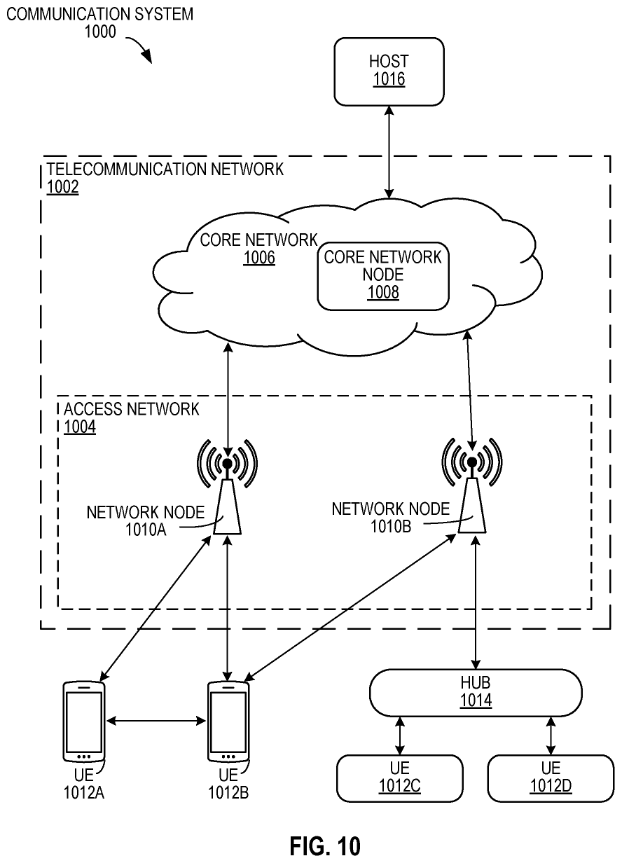

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3, Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

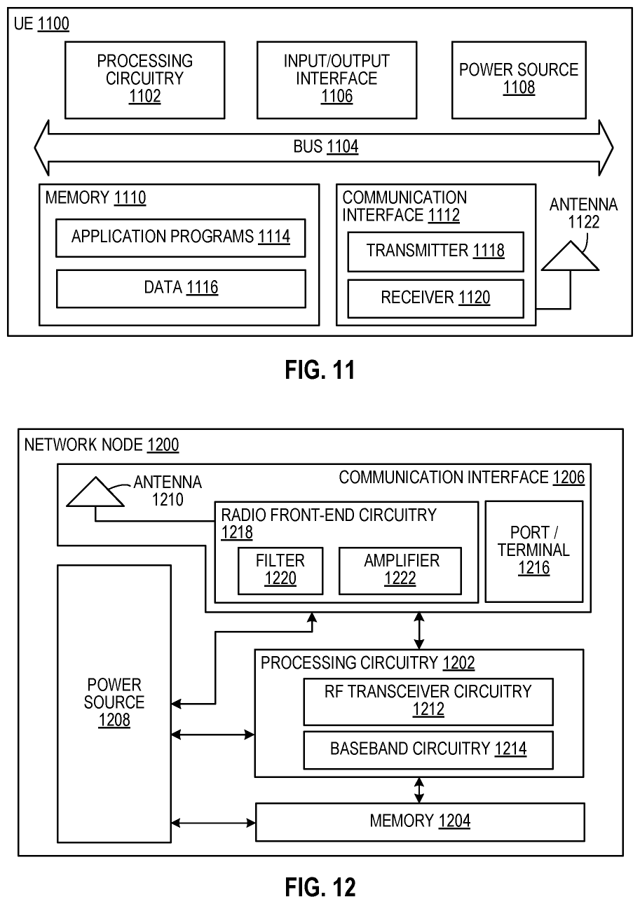

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

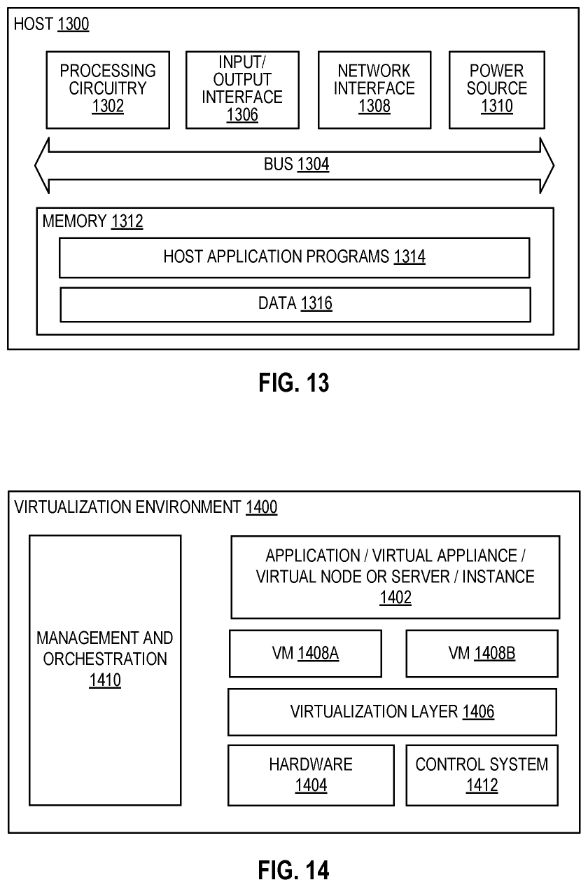

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

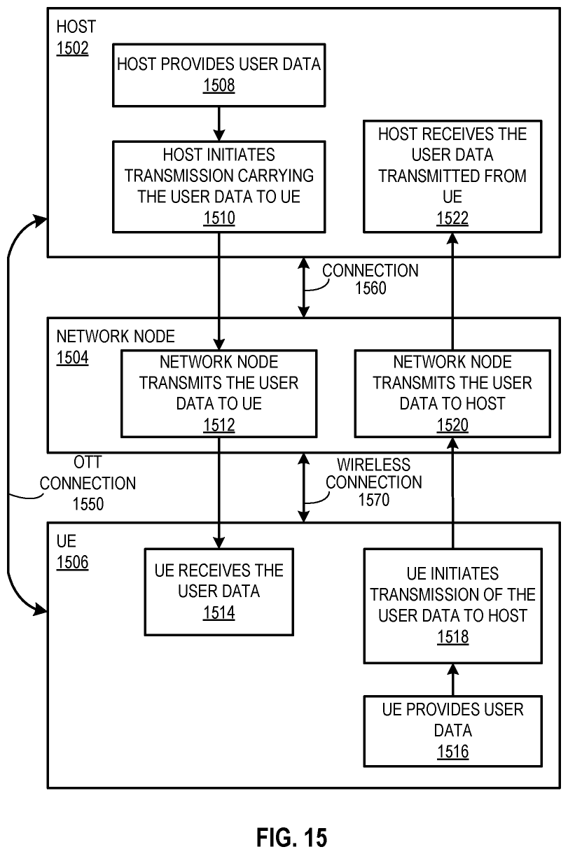

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, the teachings of these embodiments may improve the data rate and/or latency of communications, particular XR communications, and thereby provide benefits such as improved user experience and better responsiveness.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a user equipment, UE, in a wireless communication network, the method comprising:
receiving, from the wireless communication network, a configured grant that configures the UE with the set of transmission occasions for performing uplink transmission;
identifying a subset of transmission occasions, within the set of transmission occasions, that will all be used, may be used, or will not be used, by the UE to perform uplink transmission;
determining a pattern of the identified subset of transmission occasions; and
transmitting, to the wireless communication network, an indicator that indicates the pattern of the identified subset of transmission occasions.

2. The method of claim 1, wherein the set of transmission occasions comprises a set of periodically repeating transmission occasions, and wherein the pattern of the identified subset of transmission occasions comprises a periodically repeating pattern.

3. The method of claim 1, wherein the indicator comprises a bitmap of the identified subset of transmission occasions.

4. The method of any of-claims 1 to 3 claim 1, wherein the indicator indicates that one or more transmission occasions in the identified subset of transmission occasions are ‘unused.’

5. The method of claim 4, wherein transmission occasions in the identified subset of transmission occasions that are not indicated as ‘unused’ are considered as being ‘used’ or ‘may be used.”

6. The method of claim 1, wherein the indicator comprises a parameter associated with the pattern of the identified subset of transmission occasions.

7. The method of claim 1, further comprising:
determining a plurality of patterns of the identified subset of transmission occasions; and
wherein the indicator indicates the plurality of patterns of the identified subset of transmission occasions.

8. The method of claim 1, wherein the subset of transmission occasions is determined based on an expected need for a periodically repeating uplink transmission requirement by a service operated by the UE, the service operated by the UE comprising an extended reality, XR, service, and wherein the periodically repeating uplink transmission requirement comprises a requirement to perform uplink transmission of XR frames at a predetermined frame rate.

9.-17. (canceled)

18. The method of claim 1, wherein the patten indicates an identified transmission occasion as ‘unused’, ‘used’ or ‘may be used’.

19. The method of claim 1, wherein identifying the subset of transmission occasion is performed at a first protocol layer of the UE, the method further comprising triggering, by a second protocol layer of the UE that is lower than the first layer, the transmission to the wireless communication network of the indicator that indicates the identified subset of transmission occasions, wherein the first protocol layer comprises a medium access control, MAC, protocol layer, and the second protocol layer comprises a physical, PHY, protocol layer.

20. (canceled)

21. (canceled)

22. The method of claim 19, further comprising:
receiving information from a third protocol layer; and
using the information to identify the subset of the set of transmission occasions.

23. The method of claim 22, wherein the information comprises information regarding traffic that is expected to be transmitted using the subset of the set of transmission occasions.

24. The method of claim 23, wherein the information comprises information relating to traffic periodicity, jitter, and/or data size of the traffic that is expected to be transmitted using the subset of the set of transmission occasions.

25. (canceled)

26. The method of claim 1, wherein the indicator that indicates the pattern of the identified subset of transmission occasions comprises an unused transmission occasion, UTO, indicator, the method further comprising:
triggering, by a medium access control, MAC, layer, a lower layer to transmit a first UTO indicator when delivering a first MAC protocol data unit, PDU, for a first transmission occasion, TO; and
triggering, by the MAC layer, the lower layer to transmit a second UTO indicator when delivering a second MAC PDU for a second TO, where the first and second TOs are different TOs.

27. The method of claim 26, wherein the TOs that are indicated by the first UTO indicator as being ‘unused’ and referenced by second UTO indicator are also indicated by second indicator as being ‘unused’.

28. The method of claim 1, wherein the indicator identifies transmission occasions within the subset of transmission occasions based on an offset from a slot that is part of the configured grant.

29. (canceled)

30. (canceled)

31. A method performed by a network node of a wireless communication network, the method comprising:
configuring a user equipment, UE, with a configured grant that configures the UE with a set of transmission occasions for performing uplink transmission;
receiving an indicator from the UE indicating a pattern of transmission occasions in the set of transmission occasions that are configured for the UE for performing uplink transmission, the pattern of transmission occasions corresponding to a subset of transmission occasions, within the set of transmission occasions, that will all be used, or not used, by the UE to perform uplink transmission; and
allocating future transmission occasions in the set of transmission occasions based on the indicator.

32.-43. (canceled)

44. The method of claim 2, wherein the indicator comprises a bitmap of the identified subset of transmission occasions.

45. The method of claim 2, wherein the indicator indicates that one or more transmission occasions in the identified subset of transmission occasions are ‘unused.’

46. The method of claim 2, wherein the indicator comprises a parameter associated with the pattern of the identified subset of transmission occasions.
